(19) United States
(12) Patent Application Publication
(10) Pub. No.: US 2005/0189911 A1
(43) Pub. Date: Sep. 1, 2005

(54) Combination mobile phone charger

(76) Inventor: Chin-Hung Cheng, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/787,088

(22) Filed: Feb. 27, 2004

(51) Int. Cl. H02J 7/02

(52) U.S. Cl. 320/111

(57) ABSTRACT

A combination of dual mobile phone chargers has a housing and a plug removably received in the housing. The housing has a space defined in the housing to snugly yet securely receive therein the plug, a positioning cutout defined in a distal end of the housing and having first contacting plates formed on a bottom face defining the positioning cutout, a printed circuit board securely received in a bottom face defining the space and second contacting plates extending out of a side wall of the housing and engaging with the printed circuit board for connection with a wall outlet. The plug has a contacting point on a first distal end of the plug for connection with a power source, a locating cutout oppositely defined relative to the contacting point and third contacting plates formed on a bottom face defining the locating cutout.

### BACKGROUND OF THE INVENTION

1. Field of the Invention

The present invention relates to a combination of two mobile phone chargers, and more particularly to a cylindrical plug removably received in a housing having two blades extending out for connection with a main electrical outlet.

2. Description of Related Art

Recharging a mobile phone requires a charging device with two blades extending out for connection with a main electrical outlet if the mobile phone user is inside a house. If the user is onboard a vehicle, the user is able to use a cigarette lighter socket to charge the mobile phone. After the user has finished using the charging device inside the house, the user will have to find a specific place for storage of the charging device. Also, the user has to have a specific place for storage of the cigarette lighter type plug inside the vehicle. Otherwise, the user will have trouble finding the charging device or the cigarette lighter type plug next time the mobile phone is to be recharged. Either one of the charging device or the cigarette lighter type plug is small in volume so that once they are misplaced, it is not easy for the user to locate the charging gadget to charge the mobile phone.

To overcome the shortcomings, the present invention tends to provide an improved mobile phone charger to mitigate the aforementioned problems.

### SUMMARY OF THE INVENTION

The primary objective of the present invention is to provide an improved combination of two mobile phone chargers so that a user can conveniently use a single device whether in a vehicle or in a building.

In order to accomplish the aforementioned objective, the mobile phone charger of the present invention has a housing and a cigarette lighter type plug removably received in the housing. The housing has a space defined therein to fit therein the cigarette lighter type plug, a positioning cutout defined in an end of the housing and having first contacting plates mounted on a bottom face defining the positioning cutout for corresponding to two contacting plates of a charging wire of a mobile phone, second contacting plates in connection with a printed circuit board in the housing and extending out of the housing for connection with a main electrical outlet and a cigarette lighter type plug having a contacting point for connection with an onboard coil at a first end of the cigarette lighter type plug and a locating cutout oppositely defined in the cigarette lighter type plug and having third contacting plates for connection with the contacting plates of the charging wire.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view showing the elements of the present invention;

FIG. 2 is a perspective view of the cigarette lighter type plug and the housing of the present invention;

FIG. 3 is a perspective view showing the application of the cigarette lighter type plug; and

FIG. 4 is a perspective view showing the application of the housing with the cigarette lighter type plug received in the housing.

### DETAILED DESCRIPTION OF THE PREFERRED EMBODIMENT

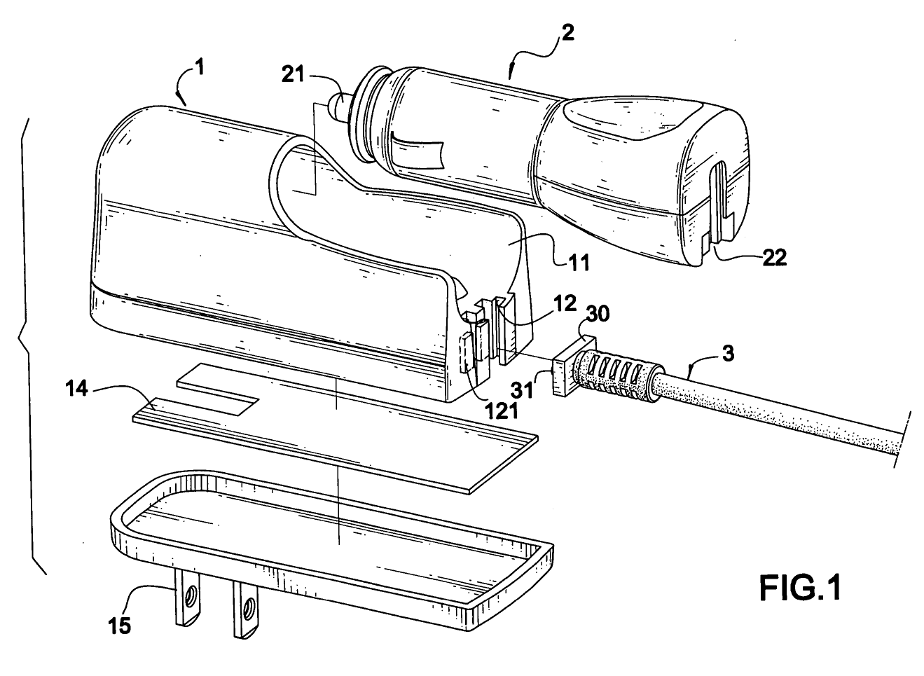

With reference to FIG. 1, the mobile phone charger constructed in accordance with the present invention has a housing (1) and a cigarette lighter type plug (2) removably received in the housing (1).

The housing (10) has a space (11) defined therein adapted to fit therein the cigarette lighter type plug (2), a positioning cutout (12) defined in an end of the housing (1) and having first contacting plates (121) mounted on a bottom face defining the positioning cutout (12) for corresponding to two contacting plates (31) of a charging wire (3) of a mobile phone (not shown) and second contacting plates (15) in connection with a printed circuit board (14) in the housing (1) and extending out of the housing (1) for connection with a mains electrical outlet (not shown).

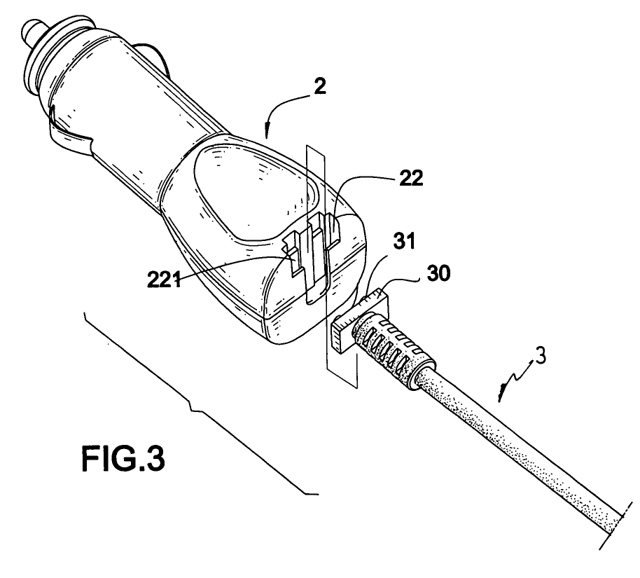

The cigarette lighter type plug (2) has a contacting point (21) at a first end of the cigarette lighter type plug for connection with an onboard coil (not shown) and a locating cutout (22) oppositely defined in the cigarette lighter type plug (2) relative to the contacting point (21) and having third contacting plates (221) (as shown in FIG. 3) for connection with the contacting plates (31) of the charging wire (3).

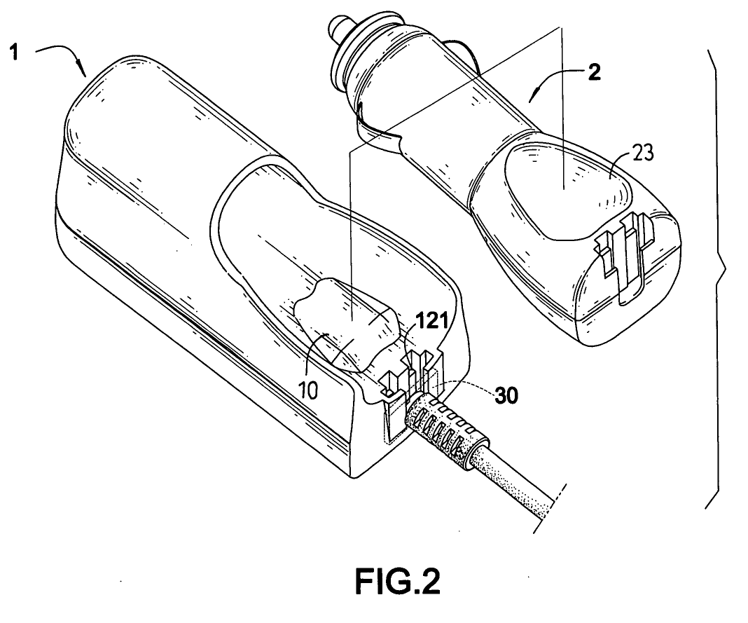

With reference to FIG. 2, it is noted that when the housing (1) is applied to connect to the charging wire (3), a block (30) at a free end of the charging wire (3) and having the contacting plates (31) formed on a side face of the block (30) is slid into the positioning cutout (12) to have the first contacting plates (121) connected to the contacting plates (31). Therefore, after the second contacting plates (15) are inserted into the mains electrical outlet, electricity is provided to the charging wire (3) and thus the mobile phone in connection with the charging wire (3) is charged.

With reference to FIG. 3, when the cigarette lighter type plug (2) of the present invention is in application with the charging wire (3), the block (30) is slid into the locating cutout (22) to allow the contacting plates (31) to engage with the third contacting plates (221). Thus electricity from the vehicle is provided to the charging wire (3) and the mobile phone in connection with the charging wire (3) is charged.

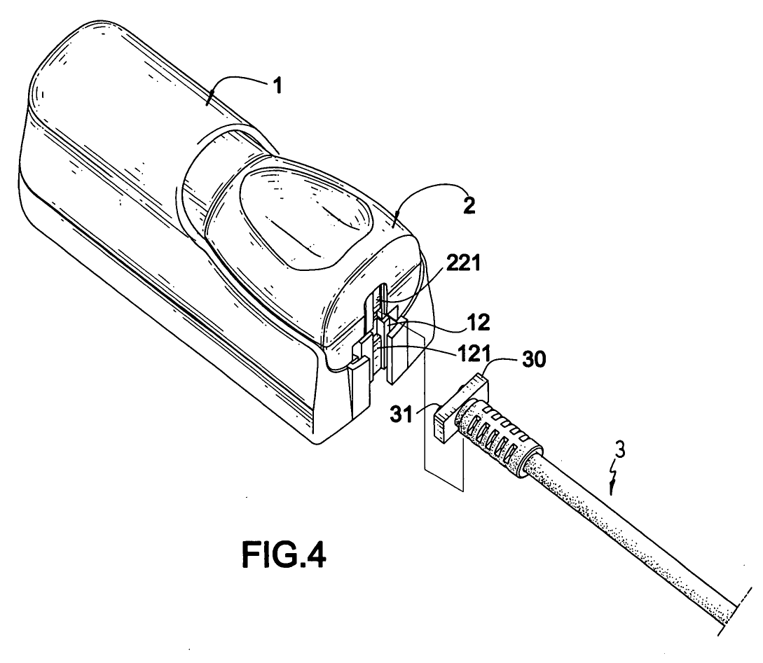

With reference to FIG. 4, when neither the housing (1) nor the cigarette lighter type plug (2) is in application with the charging wire (3), the cigarette lighter type plug (2) is first reversed. Then the distal end with the contacting point (21) of the cigarette lighter type plug (2) is inserted into the space (11) to have the cigarette lighter type plug (2) received in the space (11) and the locating cutout (22) aligned with the positioning cutout (12). Thus the cigarette lighter type plug (2) is received in the housing (1) without the worry that the cigarette lighter type plug (2) might become lost.

Referring to FIG. 2, it is noted that to further enhance the relationship between the cigarette lighter type plug (2) and the housing (1) especially when the cigarette lighter type plug (2) is received in the space (11) of the housing (1), an arcuate projection (10) is formed on a bottom defining the space (11) and an arcuate recess (23) is defined in a bottom face of the cigarette lighter type plug (2) such that when the cigarette lighter type plug (2) is received in the space (11) of the housing (1), the arcuate projection (10) received in the arcuate recess (23) is able to secure the cigarette lighter type plug (2) within the housing (1).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A dual connection mobile phone charger adapted for use with a cigarette lighter socket of a vehicle and a mains electrical outlet in a building, wherein the charger comprises: a housing for connection with the main electrical outlet and a plug removably received in the housing for electrical connection with the cigarette lighter socket, the housing having:
a space defined in the housing to snugly yet securely receive therein the cigarette lighter;
a positioning cutout defined in a distal end of the housing and having first contacting plates formed on a bottom face defining the positioning cutout;
a printed circuit board securely received in a bottom face defining the space; and
second contacting plates extending out of a side wall of the housing and engaging with the printed circuit board for connection with a wall outlet;
the plug having:
a contacting point formed on a first distal end of the plug for connection with a power source;
a locating cutout oppositely defined relative to the contacting point; and
third contacting plates formed on a bottom face defining the locating cutout,
whereby a charging wire for charging a mobile phone has a block formed on a free end of the charging wire to respectively correspond to and slidably received in the positioning cutout and the locating cutout and having contacting plates formed on a side face of the block to correspond to the first contacting plates and the third contacting plates such that either the plug or the housing is able to charge the mobile phone and afterward, the plug is able to be received in the space for storage.

2. The combination of dual mobile phone chargers as claimed in claim 1, wherein an arcuate projection is formed on a bottom face defining the space and an arcuate recess is defined in a bottom face of the cigarette lighter to correspond to and receive therein the arcuate projection when the plug is received in the space.
